(19) United States
(12) Patent Application Publication
(10) Pub. No.: US 2005/0246219 A1
(43) Pub. Date: Nov. 3, 2005

(54) Sales forecast system and method

(76) Inventors: Brian Curtiss, Bushong, KS (US); Jeffrey W. Lutes, Emporia, KS (US)

Correspondence Address: Hovey Williams LLP, Suite 400, 2405 Grand Blvd., Kansas City, MO, 64108, US

(21) Appl. No.: 10/834,686

(22) Filed: Apr. 29, 2004

(51) Int. Cl. G06F 17/60

(52) U.S. Cl. 705/10

(57) ABSTRACT

A sales forecasting system (10) and method receives weather data and make sales forecasts for one or more products using the weather data. More specifically, a manufacturer or distributor of the products may use the system (10) and method to generate a sales forecast for each product at each of a plurality of stores based on the weather data that applies to each store. The sales forecasts are then sent onto any interested parties, such as the stores or distributors associated with each store, in an effort to ensure the stores retain sufficient stock of the products to meet the sales forecast. The manufacturer may also be able to use the sales forecasts to plan manufacturing cycles of the products. In this manner, all of the interested parties are able to minimize store outages while maximizing shelf and storage space, thereby maximizing potential profits and minimizing operating costs.

### BACKGROUND OF THE INVENTION

1. Field of the Invention

The present invention relates to retail store management systems. More particularly, the present invention relates to a sales forecasting system that receives weather data and makes sales forecasts for one or more products using the weather data, thereby allowing store managers to more efficiently manage stock.

2. Description of Prior Art

Retail stores must constantly manage their inventory or stock of goods to ensure they have a large enough quantity of goods to meet customer demand, but not too much inventory which results in unnecessary storage costs and possibly unsold goods. Currently, retail stores typically manage stock by tracking sales. For example, as a product is sold, a stock count is decremented. When a count reaches a preset minimum level, a manager or an automated process typically places a resupply order. When more products are received, the count is incremented. Distribution centers typically work in a similar manner. For example, a count is decremented as a distribution center sends products to stores and incremented as more products are received.

Systems such as these work well for products with steady demand. However, since these systems are purely reactive, they do not work well for products with irregular demand. For example, when excessive amounts of snow falls in an area, customers in that area may suddenly converge on a store and buy all available snow shovels, ice scrapers, etc. As a result, the inventory of these goods is quickly depleted, resulting in lost potential sales and disappointed customers. This is also commonly seen with grocery stores, who typically run out of milk, bread, and other staples as storms approach.

This problem is typically only amplified for distributors. For example, distributors typically do not keep enough stock on hand to resupply all stores simultaneously. Therefore, when all of a distributor's stores suddenly order more products, in response to a run on a particular product, the distributor is simply not able to resupply every store.

Until now, store managers either had to accept such outages oroverstock products that might be needed during each season. Of course, overstocked products may occupy store shelves for an extended period of time, thereby displacing other products. These issues result in lost sales, inefficient use of shelf-space, as well as unsatisfied customers.

Accordingly, there is a need for an improved sales forecasting system that overcomes the limitations of the prior art.

### SUMMARY OF THE INVENTION

The present invention overcomes the above-identified problems and provides a distinct advance in the art of retail store management systems. More particularly, the present invention provides a sales forecasting system that receives weather data and makes sales forecasts for one or more products using the weather data, thereby allowing store managers to more efficiently manage stock. More specifically, a store, distributor, or manufacturer of the products may use the system to generate a sales forecast for each product at each of a plurality of stores based on the weather data that applies to each store. The sales forecasts may then be passed on to any interested parties, such as the stores or distributors and/or wholesalers associated with each store, in an effort to ensure the stores retain sufficient stock of the products to meet the sales forecasts. The distributors and/or wholesalers may use the sales forecasts to ensure that they have sufficient stock on hand to supply the stores. The manufacturer may also use the sales forecasts to plan manufacturing cycles of the products. In this manner, all of the interested parties are able to minimize store outages while maximizing shelf and storage space, thereby maximizing potential profits and minimizing operating costs.

The system may comprise one or more individual servers or conventional personal computers and preferably receives the weather data from a weather forecast server, or other provider, over a network. The sales forecasts may also be sent to the interested parties in a manner similar to that used to receive the weather data. For example, the stores and/or distributors may include one or more computers and receive the sales forecasts over the network.

The weather data may comprise one of various levels of detail. For example, the weather data preferably includes forecasted weather conditions for a selected time frame and sorted by selected geographical areas. The forecasted weather conditions may include significant forecasted weather conditions, such as snow, severe rain, or other storms, and/or insignificant forecasted weather conditions, such as partly cloudy or sunny. The selected time frame may include one to three days into the future or up to one month into the future.

The system preferably calculates the sales forecasts as a numerical score for each product at each store. The scores are preferably directly proportional to a predicted demand for the products at the stores. For example, a score of zero preferably indicates little or no demand for the product. A score of one preferably indicates normal demand for the product. A score of two preferably indicates twice normal demand for the product. It should be noted that an individual score is preferably determined for each product, as different weather conditions produce different demand for different products.

It should also be noted that different stores are expected to experience different weather conditions. Thus, the scores are preferably customized for and sent to each store and/or the distributors that supply the stores in the form of a report. The stores and/or distributors may then use the scores to manage their stock. The manufacturer may also use the scores to encourage store managers to order more of the products. Since the reports include the forecasted weather conditions, the system, the manufacturer, the stores, and/or the distributors may also further refine the scores based on previous sales figures during comparable weather conditions.

In more detail, the system analyzes a category, duration, and intensity of the forecasted weather conditions for each store in order to calculate or otherwise determine the score for each product at each store. The system may also generate modified scores, which are essentially modified versions of the scores discussed above and reflect the previous sales figures during comparable weather conditions. For example, the system may determine that, due to the forecasted weather conditions, three times normal demand is predicted for a particular product at a particular store, leading to a score of three. However, the previous sales figures may show that only approximately twice normal demand was actually experienced during comparable weather conditions, leading to a modified score of two. In this case, the managers may decide to ensure that they have only twice as many of the particular products on hand as they normally would, as indicated by the modified score, rather than three times as many.

This feature can be very advantageous, since the managers are able to make informed business decisions in an effort to more efficiently manage and stock the stores. For example, as discussed above, overstocking can easily be avoided.

Furthermore, the system can actually learn from the previous sales figures, and therefore better inform the managers. More specifically, the system may modifies its own calculations in determining the scores, accounting for the previous sales figures during comparable weather conditions. Therefore, the scores may become more and more accurate over time. Thus, the scores may be determined using only current information, such as the weather data, population numbers, median incomes, and other external factors independent of the stores themselves. Alternatively, as discussed above, the system may also consider internal factors of the stores, such as the previous sales figures, recent customer service ratings, and current market share.

By way of a relatively simply example, a large national store chain may use the system to manage stock of snow shovels throughout its stores. As a large snow producing storm moves across the country, the system would be expected to predict higher demand for the shovels at the stores in the storm's path, and thereby generate higher scores for those stores. The chain would then use the scores to ensure the stores have sufficient numbers of the shovels to meet the predicted demand as the storm progresses. For example, rather than simply overstocking every store, the chain may resupply each store just ahead of the storm. This also allows the chain to compensate as the storm strengthens or weakens. In this case, the stores may receive and use the forecasted weather conditions for only one to three days into the future, because that weather data is expected to be the most accurate and the stores can get the shovels from a regional distribution center relatively quickly.

The chain may also use the scores to replenish their internal distribution centers that supply the affected stores. For example, the chain may move shovels from a distribution center that is not expected to be affected by the storm to those that are. Additionally, or alternatively, the chain may place orders for more shovels to be delivered to the stores and/or distribution centers expected to be affected by the storm. Thus, the chain may also receive and use the forecasted weather conditions for only one to three days into the future, because that weather data is expected to be the most accurate and the chain can move the shovels between their distribution centers relatively quickly. However, the chain may also want to receive and use the forecasted weather conditions for one to two weeks into the future to plan orders for more shovels. Furthermore, the manufacturer may want to receive and use the forecasted weather conditions for up to one month into the future to plan manufacturing of the shovels.

### BRIEF DESCRIPTION OF THE DRAWINGS

A preferred embodiment of the present invention is described in detail below with reference to the attached drawing figures, wherein:

FIG. 1 is a schematic diagram of computer and other equipment that may be used to implement a preferred embodiment of the present invention;

FIG. 2 is a block diagram of modules which may be used to implement individual portions of the present invention; and

FIG. 3 is a flow chart showing the steps to receive weather data and make sales forecasts for one or more products using the weather data in accordance with a method of the present invention.

### DETAILED DESCRIPTION OF A PREFERRED EMBODIMENT

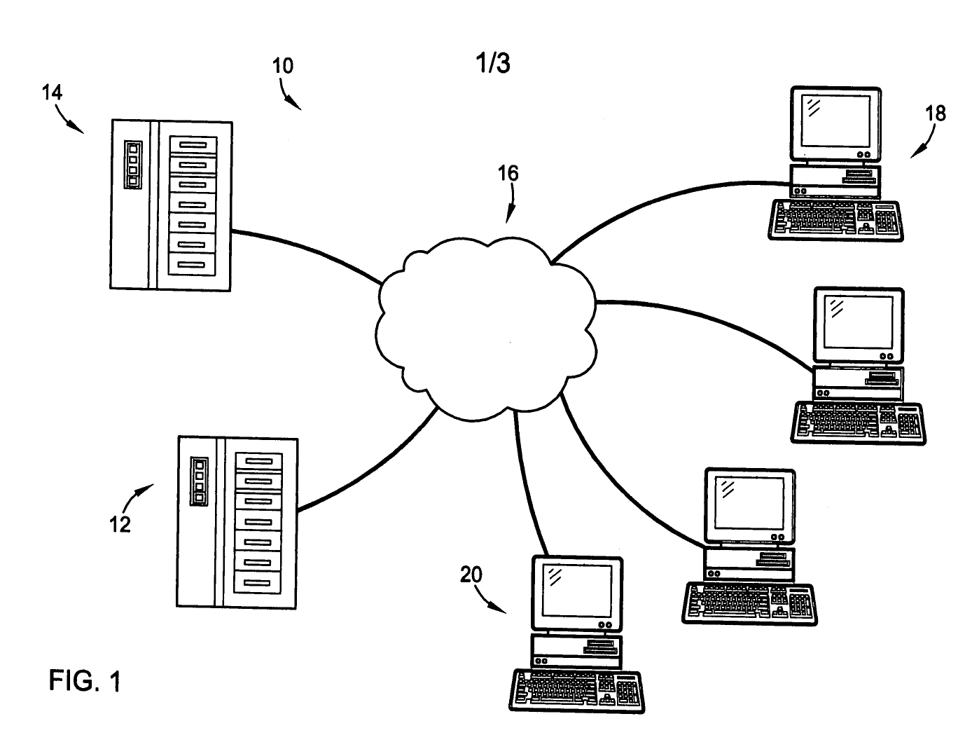

Referring to FIG. 1, the preferred system 10 and method in accordance with a preferred embodiment of the present invention are preferably implemented with use of computer equipment 12 to receive weather data and make sales forecasts for one or more products using the weather data. More specifically, a manufacturer or distributor of the products is expected to use the system 10 and method to generate a sales forecast for each product at each of a plurality of stores based on the weather data that applies to each store. The manufacturer may then pass the sales forecasts onto any interested parties, such as the stores or distributors and/or wholesalers associated with each store, in an effort to ensure the stores retain sufficient stock of the products to meet the sales forecast. The distributors and/or wholesalers may use the sales forecasts to ensure that they have sufficient stock on hand to supply the stores. The manufacturer may also use the sales forecasts to plan manufacturing cycles of the products. In this manner, all of the interested parties are able to minimize store outages while maximizing shelf and storage space, thereby maximizing potential profits and minimizing operating costs.

The computer equipment 12 may comprise one or more individual servers or conventional personal computers, such as those available from Gateway, Hewlett Packard, Dell, IBM, and Compaq, and preferably receives the weather data from a weather forecast server 14, or other provider, over a network 16. Similarly, the forecast server 14 may also comprise one or more individual servers or conventional personal computers connected to the network 16. The network 16 is preferably connected to, or may comprise a portion of, the Internet. Thus, the forecast server 14 preferably functions as a website allowing the computer equipment 12 to connect thereto. For example, the computer equipment 12 may log onto the website using conventional security techniques, such as a username and password. Alternatively, the network 16 may be completely or partially independent of the Internet and may be specifically adapted for use by the system 10.

The computer equipment 12 may receive the weather data either actively or passively. For example, the computer equipment 12 may download the weather data from the forecast server 14, such as by using a File Transfer Protocol (FTP). Alternatively, the forecast server 14 may simply push the weather data to the computer equipment 12, such as through email. In either case, the computer equipment 12 may receive the weather data with or without user intervention, such as through an automated data transfer procedure.

In another embodiment, the computer equipment 12 may be substantially stand-alone. In this case, the weather data must be transferred to the computer equipment 12. For example, the weather data may be stored on a removable memory media, which is physically transferred to the computer equipment 12. It is important to note that other commonly used methods of transferring computer files may also be used.

The sales forecasts may also be sent to the interested parties in a manner similar to that used to receive the weather data. For example, the stores may include one or more individual servers or conventional personal computers 18 and receive the sales forecasts over the network 16. Similarly, the distributors may include one or more individual servers or conventional personal computers 20 and receive the sales forecasts over the network 16. Alternatively, the stores and/or the distributors may receive the sales forecasts on paper, such as through the mail or by facsimile, or electronically on a removable memory media.

The weather data may comprise one of various levels of detail. For example, the weather data preferably includes forecasted weather conditions for a selected time frame and sorted by selected geographical areas. The forecasted weather conditions may include significant forecasted weather conditions, such as snow, severe rain, or other storms, and/or insignificant forecasted weather conditions, such as partly cloudy or sunny. The selected time frame may include one to three days into the future or up to one month into the future.

The selected areas are preferably selected according to the stores and preferably surround the stores. In the preferred embodiment, the selected areas are matched to the selected stores according to zip codes. Therefore, the weather data is preferably sorted by the zip codes and may only include forecasted weather conditions for selected ones of the stores and surrounding areas.

The level of detail may be chosen by the manufacturer or may be dictated by a provider of the weather data. Furthermore, the level of detail may change according to end-users of the sales forecasts. For example, the stores are likely concerned with shorter lead times than the distributors, who are likely concerned with shorter lead times than the manufacturer. Additionally, the stores likely serve smaller areas than the distributors, who likely serve smaller areas than the manufacturer. Furthermore, it should be noted that weather data further into the future is more likely to be inaccurate. Thus, the manufacturer may desire the weather data to include all forecasted weather conditions for one month into the future across all areas of the United States, and/or other specified countries. In this case, the manufacturer may use the sales predictions to plan their own manufacturing operations. Conversely, where the selected stores are the only end-users, the selected time frame of the weather data may be significantly shorter and the selected areas may be much smaller. For example, a single independent store may only be concerned with sales forecasts, and thus weather data, for three days into the future across as few as one zip code.

The sales forecasts are preferably generated as a report customized for the end users. For example, where the end user is one of the stores, the report preferably includes the forecasted weather conditions, for that store's zip code and surrounding zip codes, and the sales forecasts for each product in each of those zip codes. Alternatively, where the end user is one of the distributors, the report preferably includes the forecasted weather conditions, for the zip codes surrounding each store that distributor supplies, and the sales forecasts for each product in each store.

Specifically, the system 10 preferably calculates the sales forecasts as a numerical score for each product at each store. The scores are preferably directly proportional to a predicted demand for the products at the stores. For example, a score of zero preferably indicates little or no demand for the product. This may occur where the product is an ice scraper and the forecasted weather conditions are primarily sunny skies. A score of one preferably indicates normal demand for the product. This may occur where the product is the ice scraper and the forecasted weather conditions are light snow within one or two days. A score of two preferably indicates twice normal demand for the product. This may occur where the product is the ice scraper and the forecasted weather conditions are moderate snow and ice within one or two days. A score of three preferably indicates three times normal demand for the product. This may occur where the product is the ice scraper and the forecasted weather conditions are heavy snow and ice within one or two days. It should be noted that an individual score is preferably determined for each product, as different weather conditions produce different demand for different products.

It should also be noted that different stores are expected to experience different weather conditions. Thus, the scores are preferably customized for and sent to each store and/or the distributors that supply the stores. The stores and/or distributors may then use the scores to manage their stock. The manufacturer may also use the scores to encourage the managers to order more of the products. Since the reports include the forecasted weather conditions, the system 10, the manufacturer, the stores, and/or the distributors may also further refine the scores based on previous sales figures during comparable weather conditions.

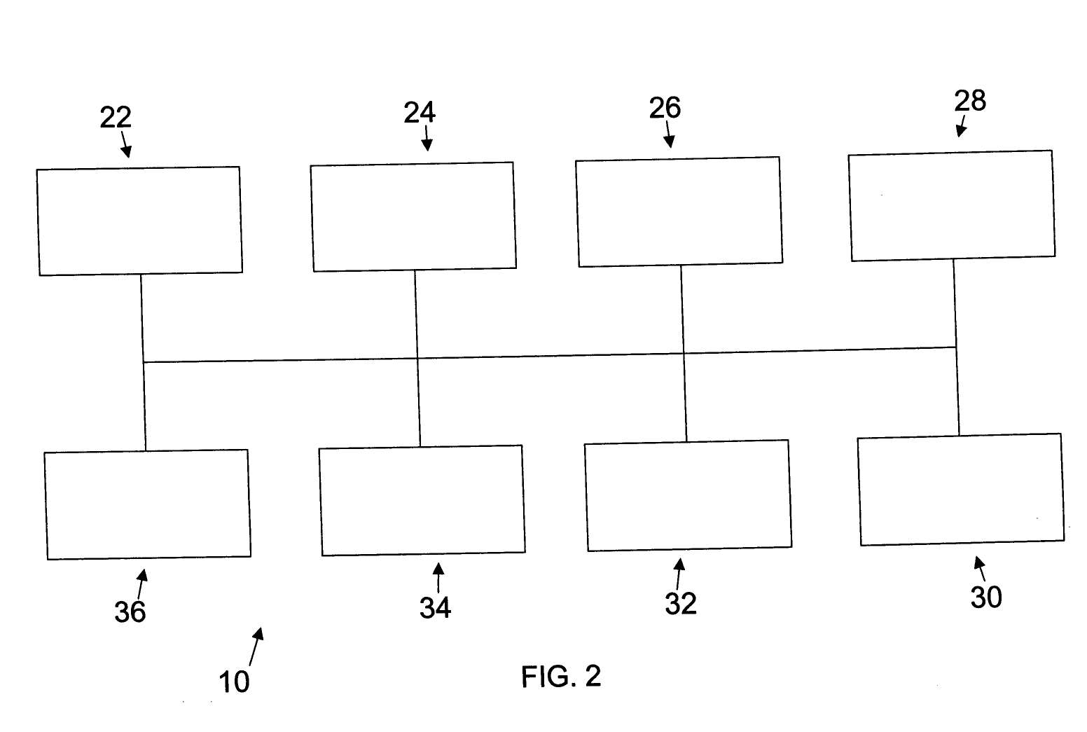

Referring also to FIG. 2, the functionality discussed herein may be provided by several modules. The modules may include a weather data receiver 22 to receive the weather data, a weather data storage volume 24 to store the weather data, a weather data decoder 26 to decode or extract the forecasted weather conditions from the weather data, a locator 28 to match the forecasted weather conditions with each of the stores, an analyzer 30 to analyze the forecasted weather conditions for each store and generate the scores for each product at each store, a report generator 32 to generate the reports containing the scores, a report distributor 34 to send the reports to the interested parties, and a historical modifier 36 to generate a modified score that accounts for the previous sales figures during comparable weather conditions.

The volume 24 preferably electronically stores the weather data, at least temporarily. If the weather data is stored long term, the weather data can be matched with actual sales figures, once those are available, thereby providing the previous sales figures for future iterations. This information can then be used by the analyzer 30 and/or the historical modifier 36 in refining or modifying the scores for the future iterations.

The decoder 26 decodes the weather data for the selected areas as necessary. For example, the decoder 26 preferably determines or extracts a category, such as snow or rain, a duration, and an intensity for each zip code from the weather data. However, the weather data may need relatively little or no decoding. In this case, the decoder 26 may simply sort and/or arrange the weather data such that the analyzer 30 may more readily utilize the forecasted weather conditions.

The locator 28 matches the forecasted weather conditions with each store, according to the zip codes. Therefore, the locator 28 preferably includes or has access to a store grid listing the zip codes for each store. Similarly, the locator 28 may match the distributors to the stores they supply, and therefore the store grid preferably also list the stores each distributer supplies. Alternatively, the locator 28 may include or have access to a distributor grid listing either the stores or zip codes served by each distributor.

The analyzer 30 analyzes the category, duration, and intensity of the forecasted weather conditions for each store in order to calculate or otherwise determine the score for each product at each store. While the scores are preferably directly proportional to the predicted demand for the products at the stores, as discussed above, other relationships may be used. For example, the score could be logarithmically related to the predicted demand. Inverse and/or nonlinear relationships are also possible, depending upon the manner in which the scores are intended to be used. Furthermore, the score may simply be related to a number of days the stores are expected to experience adverse weather conditions. However, for most applications, the scores are expected to be at least roughly proportional to the predicted demand.

The report generator 32 preferably generates the reports for the stores and/or the distributors, as well as any other interested parties. As discussed above, the report preferably includes the scores and the forecasted weather conditions for the stores. The report may also contain information relating to the previous sales figures during comparable weather conditions, if available, so that the managers may consider past performance when managing their stock. The reports may also include the modified scores, if available to the report generator 32.

The historical modifier 36 generates the modified scores, which are essentially modified versions of the scores and reflect the previous sales figures during comparable weather conditions. For example, the analyzer 30 may determine that, due to the forecasted weather conditions, three times normal demand is predicted for a particular product at a particular store, leading to a score of three. However, the previous sales figures may show that only approximately twice normal demand was actually experienced during comparable weather conditions, leading to a modified score of two. In this case, the managers may decide to ensure that they have only twice as many of the particular products on hand as they normally would, rather than three times as many as indicated by the analyzer 30.

This feature can be very advantageous, since the managers are able to make informed business decisions in an effort to more efficiently manage and stock the stores. For example, as discussed above, overstocking can easily be avoided.

Furthermore, the system 10 can learn from the previous sales figures, and therefore better inform the managers. More specifically, the analyzer 30 may be adapted to learn, such that the analyzer 30 modifies its own calculations in determining the scores, accounting for the previous sales figures during comparable weather conditions. Therefore, the scores determined by the analyzer 30 may become more and more accurate over time. Thus, the scores may be determined using only current information, such as the weather data, population numbers, median incomes, and other external factors independent of the stores themselves. Alternatively, as discussed above, the analyzer 30 may also consider internal factors of the stores, such as the previous sales figures, recent customer service ratings, and current market share.

It should be noted that any of the modules may be performed within the computer equipment 12, across different components of the computer equipment 12, or even externally to the computer equipment 12. For example, the historical modifier 36 may reside on the store's computers 18 and/or the distributor's computers 20.

Furthermore, any of the modules may be combined. For example, the receiver 22 and the volume 24 may be combined such that the weather data is stored substantially simultaneously as it is received. Similarly, the decoder 26 and the locator 28 may be combined, and thereby decode, sort, and present the weather data directly to the analyzer 30 in one step. As a final example, the report generator 32 and the report distributor 34 may be combined.

By way of a relatively simply example, a large national store chain may use the system 10 to manage stock of snow shovels throughout its stores. As a large snow producing storm moves across the country, the analyzer 30 would be expected to predict higher demand for the shovels at the stores in the storm's path, and thereby generate higher scores for those stores. The chain would then use the scores to ensure the stores have sufficient numbers of the shovels to meet the predicted demand as the storm progresses. For example, rather than simply overstocking every store, the chain may resupply each store just ahead of the storm. This also allows the chain to compensate as the storm strengthens or weakens. In this case, the stores may receive and use the forecasted weather conditions for only one to three days into the future, because that weather data is expected to be the most accurate and the stores can get the shovels from one of a plurality of internal regional distribution centers relatively quickly.

The chain may also use the scores to replenish the internal distribution centers that supply the affected stores. For example, the chain may move shovels from a distribution center that is not expected to be affected by the storm to those that are. Additionally, or alternatively, the chain may place orders for more shovels to be delivered to the stores and/or distribution centers expected to be affected by the storm. Thus, the chain may also receive and use the forecasted weather conditions for only one to three days into the future, because that weather data is expected to be the most accurate and the chain can move the shovels between their distribution centers relatively quickly. However, the chain may also want to receive and use the forecasted weather conditions for one to two weeks into the future to plan orders for more shovels. Furthermore, the manufacturer may want to receive and use the forecasted weather conditions for up to one month into the future to plan manufacturing of the shovels.

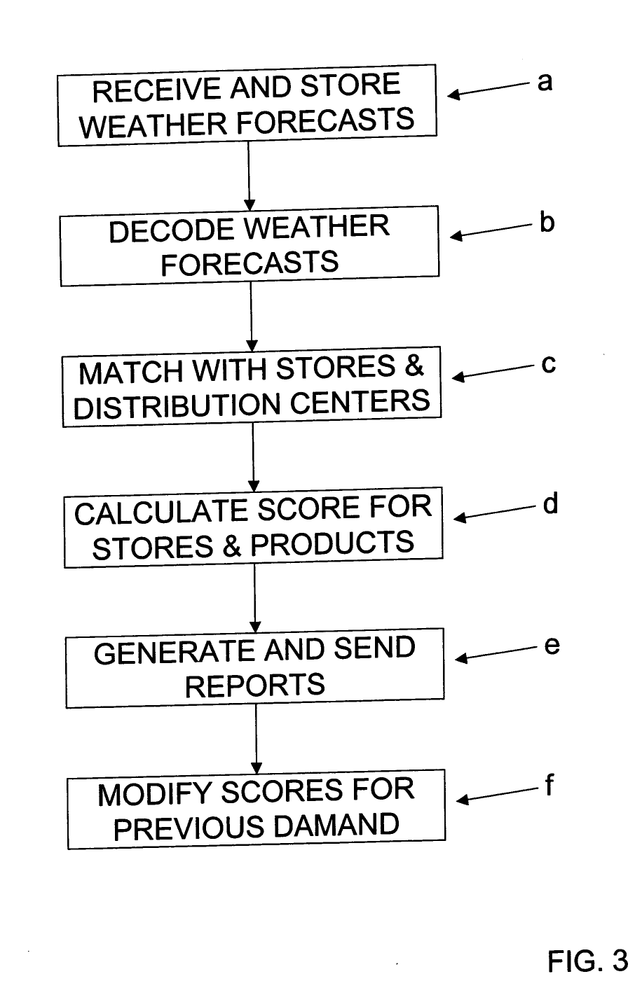

The flow chart of FIG. 3 shows the functionality and operation of a preferred implementation of the present invention in more detail. In this regard, some of the blocks of the flow chart may represent a module segment or portion of code of the program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved. Furthermore, Tables 1-5 simply represent examples and are intended to illustrate the functionality of the system 10 without limiting the scope of the claims. The system 10 will likely operate with information comparable to that shown in the Tables, but greater in breadth, depth, and/or quantity.

In use, as shown in FIG. 3, the system 10 receives and stores the weather data for the selected areas according to the zip codes, as shown in step a. An example of the weather data is shown in Table 1 below. It is assumed that zero precipitation can be equated with zero snow or rain fall and may also indicate partly cloudy and/or sunny skies. Similarly, a precipitation of one may indicate light snow or rain fall. Thus, with a temperature near thirty degrees, and a precipitation of one, the decoder 26 and/or the analyzer 30 may determine that light snow has been forecast. Alternatively, the weather data may be in plain terms such that neither the decoder 26 nor the analyzer 30 need perform any extrapolation or interpretation.

TABLE 1
Example Weather Data

| | Day 1 | | Day 2 | | Day 3 | |
|---|---|---|---|---|---|---|
| Zip | Temp | Precip. | Temp | Precip. | Temp | Precip. |
| 64101 | 25 | 0 | 30 | 3 | 32 | 2 |
| 64102 | 25 | 0 | 30 | 3 | 32 | 2 |
| 64103 | 25 | 0 | 30 | 3 | 32 | 2 |
| 64105 | 25 | 0 | 30 | 3 | 32 | 2 |
| 64106 | 25 | 0 | 30 | 3 | 32 | 2 |
| 64108 | 32 | 1 | 26 | 4 | 33 | 3 |
| 64109 | 32 | 1 | 26 | 4 | 33 | 3 |
| 64110 | 30 | 1 | 27 | 3 | 31 | 0 |
| 64111 | 32 | 1 | 26 | 4 | 33 | 3 |
| 64112 | 30 | 1 | 27 | 3 | 31 | 0 |
| 64113 | 30 | 1 | 27 | 3 | 31 | 0 |
| 64123 | 32 | 1 | 26 | 4 | 33 | 3 |
| 64124 | 32 | 1 | 26 | 4 | 33 | 3 |
| 64125 | 32 | 1 | 26 | 4 | 33 | 3 |
| 64126 | 32 | 1 | 26 | 4 | 33 | 3 |
| 64127 | 32 | 1 | 26 | 4 | 33 | 3 |
| 64128 | 32 | 1 | 26 | 4 | 33 | 3 |
| 64129 | 30 | 1 | 27 | 3 | 31 | 0 |
| 64130 | 30 | 1 | 27 | 3 | 31 | 0 |

The system 10 then decodes the weather data to determine the category, duration, and intensity for each zip code, as shown in step b. An example of the forecasted weather conditions is shown in Table 2 below, given Table 1.

TABLE 2
Example Forecasted Weather Conditions

| | Day 1 | Day 2 | Day 3 |
|---|---|---|---|
| Zip | Weather | Weather | Weather |
| 64101 | | Hvy Snow | Mod Snow |
| 64102 | | Hvy Snow | Mod Snow |
| 64103 | | Hvy Snow | Mod Snow |
| 64105 | | Hvy Snow | Mod Snow |
| 64106 | | Hvy Snow | Mod Snow |
| 64108 | Lt Snow | Ext Snow | Hvy Snow |
| 64109 | Lt Snow | Ext Snow | Hvy Snow |
| 64110 | Lt Snow | Hvy Snow | |
| 64111 | Lt Snow | Ext Snow | Hvy Snow |
| 64112 | Lt Snow | Hvy Snow | |
| 64113 | Lt Snow | Hvy Snow | |
| 64123 | Lt Snow | Ext Snow | Hvy Snow |
| 64124 | Lt Snow | Ext Snow | Hvy Snow |
| 64125 | Lt Snow | Ext Snow | Hvy Snow |
| 64126 | Lt Snow | Ext Snow | Hvy Snow |
| 64127 | Lt Snow | Ext Snow | Hvy Snow |
| 64128 | Lt Snow | Ext Snow | Hvy Snow |
| 64129 | Lt Snow | Hvy Snow | |
| 64130 | Lt Snow | Hvy Snow | |

The system 10 then matches the forecasted weather conditions to each store and each distributor that supplies each store, as shown in step c. A sample store grid is shown in Table 3 below.

TABLE 3
Example Store Grid

| Zip | Store | Distributor |
|---|---|---|
| 64105 | S105 | D123 |
| 64113 | S113 | D124 |
| 64128 | S128 | D124 |

The system 10 then calculates the score for each product at each store, as shown in step d. Finally, the system 10 generates and sends the reports to the stores and distributors expected to the affected by the forecasted weather conditions, as shown in step e. A sample store report for store S113 is shown in Table 4 below, given Table 2. For example, as Table 4 suggests, the predicted demand for ice melting products may be approximately twice normal on Day 1 with light snow, may be approximately three times normal on Day 2 with heavy snow and following Day 1's light snow, and may be approximately twice normal following Day 2's heavy snow. Similarly, the predicted demand for ice scrapers and snow brushes may be approximately twice normal on Day 1 with light snow, may be approximately three times normal on Day 2 with heavy snow and following Day 1's light snow, and may be approximately normal following Day 2's heavy snow. Finally, the predicted demand for snow shovels may be approximately normal on Day 1 with light snow, may be approximately three times normal on Day 2 with heavy snow and following Day 1's light snow, and may be approximately twice normal following Day 2's heavy snow.

TABLE 4
Example Store Report for Store S113

| Product | Day 1 | Day 2 | Day 3 |
|---|---|---|---|
| Ice Melting Prod. | 2 | 3 | 2 |
| Ice Scrapers | 2 | 3 | 1 |
| Snow Brushes | 2 | 3 | 1 |
| Snow Shovels | 1 | 3 | 2 |

A sample distributor report for distributor D124 is shown in Table 5 below. For example, as Table 5 suggests, the predicted demand for the distributor may be calculated by averaging the scores for each store associated with the distributor, S113 and S128 in the case. Furthermore, each distributor report may include the associated store reports. As shown in Table 5, the distributor's scores may be shifted prior to each store's scores, thereby reflecting a lead time required to distribute the products to the stores.

TABLE 5
Example Distributor Report for Distributor D124

| Product | Day 0 | Day 1 | Day 2 |
|---|---|---|---|
| Ice Melting Prod. | 2 | 4 | 3 |
| Ice Scrapers | 2 | 4 | 2 |
| Snow Brushes | 2 | 4 | 2 |
| Snow Shovels | 1 | 4 | 3 |
| Product | Day 1 | Day 2 | Day 3 |

S113

| | | | |
|---|---|---|---|
| Ice Melting Prod. | 2 | 3 | 2 |
| Ice Scrapers | 2 | 3 | 1 |
| Snow Brushes | 2 | 3 | 1 |
| Snow Shovels | 1 | 3 | 2 |

S128

| | | | |
|---|---|---|---|
| Ice Melting Prod. | 2 | 4 | 4 |
| Ice Scrapers | 2 | 4 | 3 |
| Snow Brushes | 2 | 4 | 3 |
| Snow Shovels | 1 | 4 | 4 |

The stores and/or the distributors may modify the scores contained in the reports based on the previous sales figures for each product during comparable weather conditions, as shown in step f. For example, distributor D124 may determine from the previous sales figures that store S128 has never sold more than three times normal demand of any product. In this case, distributor D124 may revise their report to that shown in Table 6 below.

TABLE 6
Example Distributor Report for Distributor D124

| Product | Day 0 | Day 1 | Day 2 |
|---|---|---|---|
| Ice Melting Prod. | 2 | 3 | 3 |
| Ice Scrapers | 2 | 3 | 2 |
| Snow Brushes | 2 | 3 | 2 |
| Snow Shovels | 1 | 3 | 3 |
| Product | Day 1 | Day 2 | Day 3 |

S113

| | | | |
|---|---|---|---|
| Ice Melting Prod. | 2 | 3 | 2 |
| Ice Scrapers | 2 | 3 | 1 |
| Snow Brushes | 2 | 3 | 1 |
| Snow Shovels | 1 | 3 | 2 |

S128

| | | | |
|---|---|---|---|
| Ice Melting Prod. | 2 | 3 | 3 |
| Ice Scrapers | 2 | 3 | 3 |
| Snow Brushes | 2 | 3 | 3 |
| Snow Shovels | 1 | 3 | 3 |

It should be apparent that the stores and/or distributors need advanced warning in order to prepare for the predicted demand for the products. On the other hand, neither the stores nor the distributors need to be overwhelmed with constantly changing information. Since weather forecasts frequently change, a balance must be stricken between too much and too little information, taking into account product order lead times. With these and other concerns in mind, it has been found that at a maximum, each store and/or distributor should receive their report on a daily basis. Alternatively, at a minimum, each store and/or distributor should receive their report on a weekly basis.

While the present invention has been described above, it is understood that substitutions may be made. For example, the system 10 may be used with other products and/or other forecasted phenomena or events. Additionally, rather than the score being numerical, as discussed herein, the score could be alphanumeric, simply alphabetic, or even text based. For example, the score could be a self explanatory text statement. Furthermore, the weather data may be received in virtually any form, with any common variables, such as high temperature, low temperature, wind speed and direction, barometric pressure, humidity, etc. Finally, the system 10 may consider present stock levels, when determining the scores. In this manner, each score could be related to a quantity to be ordered, accounting for both the predicted demand and the present stock levels. These and other minor modifications are within the scope of the present invention.

1. A sales forecasting system operable to forecast sales of selected products based on forecasted weather conditions, the system comprising:
a weather forecast receiver operable to receive forecasted weather conditions for a plurality of areas;
a locator operable to match each area with one of a plurality of stores;
an analyzer operable to analyze the forecasted weather conditions for each store in order to determine a predicted demand for each product at each store; and
a report generator operable to generate a report indicating the predicted demand for each product at each store.

2. The system as set forth in claim 1, further including a weather decoder operable to decode the forecasted weather conditions for each area.

3. The system as set forth in claim 1, wherein the analyzer calculates a numerical score for each product at each store.

4. The system as set forth in claim 3, wherein the analyzer analyzes a category, duration, and intensity of the forecasted weather conditions for each store, in determining the scores.

5. The system as set forth in claim 3, wherein the score is directly proportional to the predicted demand for each product at each store.

6. The system as set forth in claim 1, wherein the analyzer further determines the predicted demand for each product at each store based on the forecasted weather conditions for each store for each of a plurality of days into the future.

7. The system as set forth in claim 1, further including a report distributor operable to send each report to each store.

8. The system as set forth in claim 1, wherein the report distributor is further operable to send each report to a distributor that supplies each store.

9. The system as set forth in claim 1, further including a historical modifier operable to modify each score according to previous sales figures for each product at each store during comparable weather conditions.

10. A sales forecasting system operable to forecast sales of selected products based on forecasted weather conditions, the system comprising:
a weather forecast receiver operable to receive the forecasted weather conditions for a plurality of areas;
a weather forecast storage volume operable to electronically store the forecasted weather conditions;
a weather forecast decoder operable to decode the forecasted weather conditions for each area to determine a category, a duration, and an intensity for each area;
a locator operable to match each area with one of a plurality of stores and match each store with one of a plurality of distributors;
an analyzer operable to analyze the category, duration, and intensity for each store in order to calculate a numerical score for each product at each store, wherein the score is directly proportional to a predicted demand for each product at each store;
a report generator operable to generate a report for each distributor listing each score for each product at each store supplied by that distributor;
a report distributor operable to send each report to each distributor; and
a historical modifier operable to modify each score according to previous sales figures for each product at each store during comparable weather conditions.

11. A method of forecasting sales of selected products based on forecasted weather conditions, the method the steps comprising of:
receiving the forecasted weather conditions for a plurality of areas;
decoding the forecasted weather conditions for each area to determine a category, a duration, and an intensity for each area;
matching each area with each of a plurality of stores;
analyzing the forecasted weather conditions for each store in order to determine a predicted demand for each product at each store; and
generating a report indicating the predicted demand for each product at each store.

12. The method as set forth in claim 11, further including the step of electronically storing the forecasted weather conditions.

13. The method as set forth in claim 11, further including the step of calculating a numerical score for each products at each store.

14. The method as set forth in claim 13, wherein the score is determined by analyzing the category, duration, and intensity the forecasted weather conditions for each store.

15. The method as set forth in claim 13, wherein the score is directly proportional to the predicted demand for each product at each store.

16. The method as set forth in claim 11, further including the step of sending each report to each store.

17. The method as set forth in claim 11, further including the step of matching each store with one of a plurality of distributors.

18. The method as set forth in claim 17, further including the step of sending the reports to the distributors.

19. The method as set forth in claim 11, further including the step of modifying each score according to previous sales figures for each product at each store during comparable weather conditions.

20. A method of forecasting sales of selected products based on forecasted weather conditions, the method the steps comprising of:
receiving the forecasted weather conditions for a plurality of areas;
electronically storing the forecasted weather conditions;
decoding the forecasted weather conditions for each area to determine a category, a duration, and an intensity for each area;
matching each area with one of a plurality of stores;
matching each store with one of a plurality of distributors;
calculating a numerical score for each product at each store, wherein the score is directly proportional to a predicted demand for each product at each store;
generating a report for each distributor listing each score for each product at each store matched with that distributor;
sending the reports to the distributors; and
modifying each score according to previous sales figures for each product at each store during comparable weather conditions.
